(19) United States
(12) Patent Application Publication
(10) Pub. No.: US 2020/0379395 A1
(43) Pub. Date: Dec. 3, 2020

(54) SHEET CONVEYANCE DEVICE AND IMAGE FORMING APPARATUS INCORPORATING SAME

(71) Applicants: Takeshi FUKAO, Kanagawa (JP); Masakazu IMAI, Kanagawa (JP); Atsushi NAGATA, Kanagawa (JP); Ryo HASEGAWA, Tokyo (JP)

(72) Inventors: Takeshi FUKAO, Kanagawa (JP); Masakazu IMAI, Kanagawa (JP); Atsushi NAGATA, Kanagawa (JP); Ryo HASEGAWA, Tokyo (JP)

(21) Appl. No.: 16/876,130

(22) Filed: May 18, 2020

(30) Foreign Application Priority Data
May 28, 2019 (JP) 2019-099116
Jan. 6, 2020 (JP) 2020-000497

(51) Int. Cl. G03G 15/00; B65H 29/14

(52) U.S. Cl. CPC G03G 15/657; B65H 2515/716; B65H 29/14

(57) ABSTRACT

A sheet conveyance device includes a conveyor configured to convey a sheet in a sheet conveyance path and a discharger disposed at an intermediate position in the sheet conveyance path. The conveyor is configured to contact the sheet in a contact range within and narrower than a passage range where the sheet passes through the sheet conveyance path in a width direction of the sheet. The discharger is disposed close to the sheet that the conveyor is conveying in the sheet conveyance path, in a range different from the contact range and configured to remove static electricity from the sheet that the conveyor is conveying in the sheet conveyance path.

### CROSS-REFERENCE TO RELATED APPLICATIONS

This patent application is based on and claims priority pursuant to 35 U.S.C. § 119(a) to Japanese Patent Application Nos. 2019-099116, filed on May 28, 2019 and 2020-000497, filed on Jan. 6, 2020, in the Japan Patent Office, the entire disclosure of each of which is hereby incorporated by reference herein.

### BACKGROUND

### Technical Field

Embodiments of the present disclosure generally relate to a sheet conveyance device to convey a sheet such as a paper sheet, and an image forming apparatus, such as a copier, a printer, a facsimile machine, or a multifunction peripheral (MFP) having at least two of such capabilities, incorporating the sheet conveyance device.

### Description of the Related Art

In certain image forming apparatuses, such as copiers, printers, and the like, a sheet conveyance device is disposed in a sheet conveyance path from a transfer belt, such as a secondary transfer belt, to a fixing device to convey a sheet fed by the transfer belt toward the fixing device.

### SUMMARY

Embodiments of the present disclosure describe an improved sheet conveyance device that includes a conveyor configured to convey a sheet in a sheet conveyance path and a discharger disposed at an intermediate position in the sheet conveyance path. The conveyor is configured to contact the sheet in a contact range within and narrower than a passage range where the sheet passes through the sheet conveyance path in a width direction of the sheet. The discharger is disposed close to the sheet that the conveyor is conveying in the sheet conveyance path, in a range different from the contact range and configured to remove static electricity from the sheet that the conveyor is conveying in the sheet conveyance path.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view illustrating a configuration of an image forming apparatus according to an embodiment of the present disclosure;

FIG. 2 is an enlarged schematic view illustrating a configuration of an image forming unit of the image forming apparatus according to an embodiment of the present disclosure;

FIG. 3 is a schematic view of a secondary-transfer belt device, a sheet conveyance device, and a fixing device of the image forming apparatus and the surrounding structure according to an embodiment of the present disclosure;

FIG. 4 is a top view of the secondary-transfer belt device, the sheet conveyance device, and the fixing device according to an embodiment of the present disclosure;

FIGS. 5A and 5B are schematic views of a part of a comparative image forming apparatus;

FIG. 6 is a top view of a sheet conveyance device and the surrounding structure according to a first variation of the present disclosure;

FIGS. 7A and 7B are top views of a sheet conveyance device and the surrounding structure according to a second variation of the present disclosure;

FIG. 8 is a top view of a sheet conveyance device and the surrounding structure according to a third variation of the present disclosure;

FIG. 9 is a schematic view of a sheet conveyance device and the surrounding structure according to a fourth variation of the present disclosure;

FIG. 10 is a top view of the sheet conveyance device and the surrounding structure in FIG. 9;

FIG. 11 is a graph illustrating a relation between a potential difference of a sheet, which is conveyed by the sheet conveyance device, before and after discharging and an image dust and discharge mark grade; and

FIG. 12 is a graph illustrating a relation between a position of a sheet conveyed by the sheet conveyance device in a conveyance direction and a potential of the sheet.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views, and redundant descriptions are omitted or simplified below as required.

### DETAILED DESCRIPTION

Embodiments of the present disclosure are described in detail with reference to drawings.

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

As used herein, the singular forms “a”, “an”, and “the” are intended to include the plural forms as well, unless the context clearly indicates otherwise.

It is to be noted that the suffixes Y, M, C, and K attached to each reference numeral indicate only that components indicated thereby are used for forming yellow, magenta, cyan, and black images, respectively, and hereinafter may be omitted when color discrimination is not necessary.

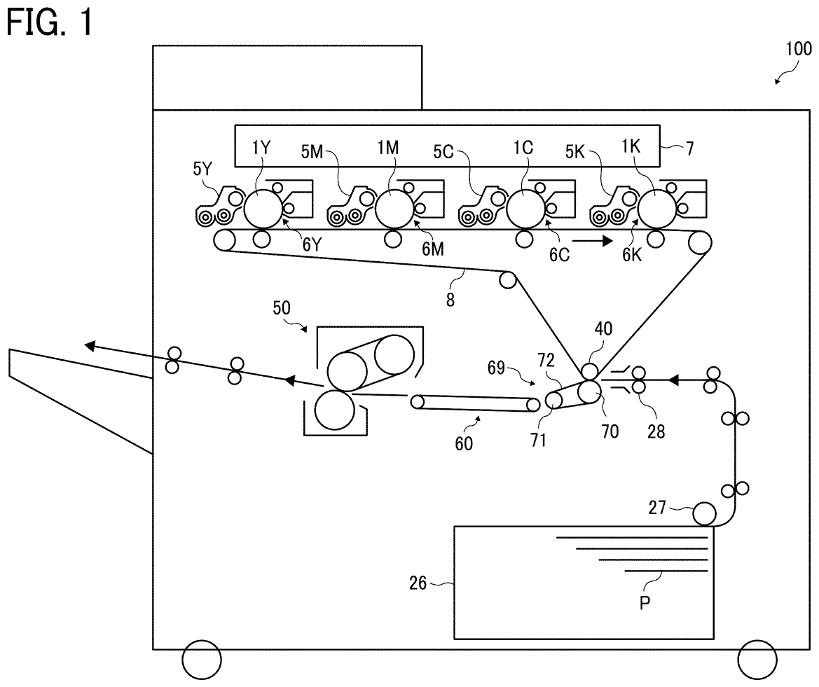

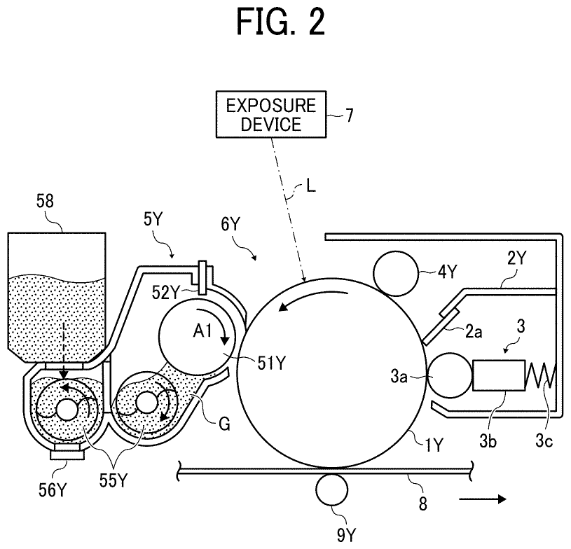

A configuration and operation of an image forming apparatus 100 is described below with initial reference to FIGS. 1 and 2.

FIG. 1 is a schematic view illustrating the configuration of the image forming apparatus 100, which in the present embodiment is a printer. FIG. 2 is an enlarged schematic view illustrating an image forming unit 6Y of the image forming apparatus 100.

As illustrated in FIG. 1, an intermediate transfer belt device including an intermediate transfer belt 8 is disposed in the middle of the image forming apparatus 100. The image forming units 6Y, 6M, 6C, and 6K, respectively corresponding to yellow, magenta, cyan, and black, are arranged in parallel, facing the intermediate transfer belt 8. A secondary-transfer belt device 69, a sheet conveyance device 60, and a fixing device 50 are disposed below the intermediate transfer belt 8. A sheet feeder 26 is disposed further below the intermediate transfer belt 8.

The image forming unit 6Y for yellow is described below. The other three image forming units 6M, 6C, and 6K have a similar configuration to that of the yellow image forming unit 6Y except for the color of toner used therein and form magenta, cyan, and black toner images, respectively. Therefore, descriptions of the other three image forming units 6M, 6C, and 6K are omitted to avoid redundancy.

With reference to FIG. 2, it can be seen that the image forming unit 6Y for yellow includes a photoconductor drum 1Y and further includes a charging device 4Y, a developing device 5Y, a cleaning device 2Y, a lubricant applicator 3, a discharge device, and the like disposed around the photoconductor drum 1Y. Image formation processes, namely, charging, exposure, development, transfer, cleaning, and discharging processes are performed on the photoconductor drum 1Y, and thus a yellow toner image is formed on the photoconductor drum 1Y.

With continued reference to FIG. 2, it can be seen that the photoconductor drum 1Y is rotated counterclockwise in FIG. 2 by a main motor. The charging device 4Y uniformly charges the surface of the photoconductor drum 1Y (charging process). Then, the charged surface of the photoconductor drum 1Y reaches a position where an exposure device 7 irradiates the surface of the photoconductor drum 1Y with a laser beam L, and the photoconductor drum 1Y is scanned with the laser beam L in a width direction at the position, thereby forming an electrostatic latent image for yellow on the surface of the photoconductor drum 1Y (exposure process). The width direction is a main-scanning direction perpendicular to the surface of the paper on which FIGS. 1 and 2 are drawn.

The surface of the photoconductor drum 1Y carrying the electrostatic latent image reaches a position opposite the developing device 5Y, and the electrostatic latent image is developed into a toner image of yellow at the position (development process). When the surface of the photoconductor drum 1Y carrying the toner image reaches a position opposite a primary transfer roller 9Y via the intermediate transfer belt 8, the toner image on the surface of the photoconductor drum 1Y is transferred onto the surface of the intermediate transfer belt 8 at the position (primary transfer process). After the primary transfer process, a certain amount of residual toner, which is not transferred to the intermediate transfer belt 8, remains on the photoconductor drum 1Y.

When the surface of the photoconductor drum 1Y reaches a position opposite the cleaning device 2Y, a cleaning blade 2a collects the residual toner from the photoconductor drum 1Y into the cleaning device 2Y (cleaning process). The cleaning device 2Y includes a lubricant supply roller 3a, a solid lubricant 3b, and a compression spring 3c, which constitute a lubricant applicator 3 for the photoconductor drum 1Y. The lubricant supply roller 3a rotating clockwise in FIG. 2 scrapes a small amount of lubricant from the solid lubricant 3b and applies the lubricant to the surface of the photoconductor drum 1Y.

Subsequently, the discharge device removes residual potentials from the photoconductor drum 1Y to complete a sequence of image forming processes performed on the photoconductor drum 1Y.

The above-described image forming processes are performed in the image forming units 6M, 6C, and 6K similarly to the yellow image forming unit 6Y. That is, the exposure device 7 disposed above the image forming units 6M, 6C, and 6K irradiates photoconductor drums 1M, 1C, and 1K of the image forming units 6M, 6C, and 6K with the laser beams L based on image data. Then, the toner images formed on the photoconductor drums 1M, 1C, and 1K through the development process of the developing devices 5M, 5C, and 5K are primarily transferred therefrom and superimposed onto the intermediate transfer belt 8. Thus, a multicolor toner image is formed on the intermediate transfer belt 8.

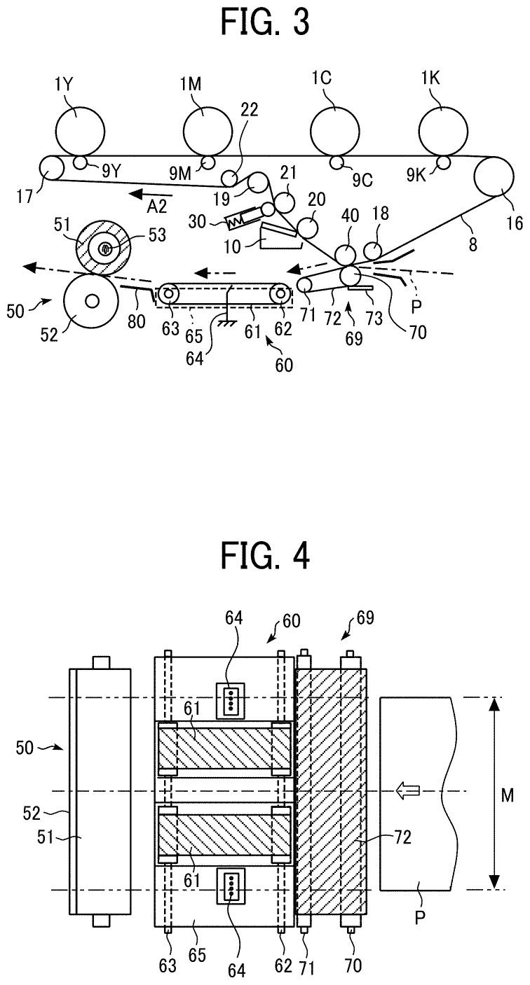

FIG. 3 is a schematic view of the secondary-transfer belt device 69, the sheet conveyance device 60, and the fixing device 50 of the image forming apparatus and the surrounding structure according. The intermediate transfer belt 8 is stretched around and supported by a plurality of rollers 16 through 22 and 40, and is rotated in the direction indicated by arrow A2 in FIG. 3 by a drive roller 16, which is one of the plurality of rollers, driven by a drive motor. The four primary transfer rollers 9Y, 9M, 9C, and 9K are pressed against the corresponding photoconductor drums 1Y, 1M, 1C, and 1K, respectively, via the intermediate transfer belt 8 to form primary transfer nips. Transfer voltages (primary transfer biases) opposite in polarity to toner are applied to the primary transfer rollers 9Y, 9M, 9C, and 9K.

While rotating in the direction indicated by arrow A2 in FIG. 3, the intermediate transfer belt 8 passes through the primary transfer nips between the photoconductor drums 1Y, 1M, 1C, and 1K and the respective primary transfer rollers 9Y, 9M, 9C, and 9K. Then, the single-color toner images are primarily transferred from the photoconductor drums 1Y, 1M, 1C, and 1K and superimposed on the intermediate transfer belt 8, thereby forming the multicolor toner image on the intermediate transfer belt 8 (primary transfer process).

Thereafter, the intermediate transfer belt 8 carrying the multicolor toner image reaches a position opposite a secondary transfer belt 72 as a transfer belt. At this position, a secondary-transfer backup roller 40 presses against the secondary transfer roller 70 via the intermediate transfer belt 8 and the secondary transfer belt 72, thereby forming a secondary transfer nip. The multicolor (four-color) toner image on the intermediate transfer belt 8 is transferred onto a sheet P (e.g., a paper sheet) conveyed to the secondary transfer nip (secondary transfer process). At that time, residual toner that is not transferred onto the sheet P remains on the surface of the intermediate transfer belt 8.

The intermediate transfer belt 8 reaches a position opposite a belt cleaning device 10. At this position, the belt cleaning device 10 removes substances adhering to the surface of the intermediate transfer belt 8 (e.g., residual toner). Subsequently, the intermediate transfer belt 8 reaches a position opposite a lubricant applicator 30 for the intermediate transfer belt 8. Lubricant is applied to the surface of the intermediate transfer belt 8 by the lubricant applicator 30 at the position to complete a series of image transfer processes performed on the intermediate transfer belt 8.

From FIG. 1, it can be seen that the sheet P is conveyed from the sheet feeder 26 disposed in a lower portion of the image forming apparatus 100 to the secondary transfer nip via a feed roller 27 and a registration roller pair 28. Specifically, the sheet feeder 26 contains a stack of multiple sheets P such as paper sheets piled one on another. As the feed roller 27 rotates counterclockwise in FIG. 1, the top sheet P of the stack of multiple sheets P in the sheet feeder 26 is fed toward a nip between the registration roller pair 28 through a sheet conveyance path.

The registration roller pair (timing roller pair) 28 temporarily stops rotating, stopping the sheet P with a leading edge of the sheet P nipped between the registration roller pair 28. Then, as the registration roller pair 28 rotates, the sheet P is guided by a guide plate and conveyed to the secondary transfer nip, timed to coincide with the arrival of the multicolor toner image on the intermediate transfer belt 8. Thus, the desired multicolor toner image is transferred onto the sheet P.

The sheet P, onto which the multicolor toner image is transferred at the secondary transfer nip, is conveyed on the secondary transfer belt 72 and separated from the secondary transfer belt 72, and then the sheet conveyance device 60 conveys the sheet P to a fixing device 50. In the fixing device 50, a fixing roller 51 and a pressure roller 52 apply heat and pressure to the sheet P to fix the multicolor toner image on the sheet P (fixing process).

The sheet P is conveyed through the sheet conveyance path and ejected by an output roller pair to the outside of the image forming apparatus 100. The sheets P ejected by the output roller pair are sequentially stacked as output images on a stack tray to complete a series of image forming processes (printing operations) performed by the image forming apparatus 100.

Next, a detailed description is provided of a configuration and operation of the developing device 5Y of the image forming unit 6Y, with reference again to FIG. 2.

The developing device 5Y includes a developing roller 51Y opposite the photoconductor drum 1Y, a doctor blade 52Y opposite the developing roller 51Y, two conveying screws 55Y disposed in a developer storage of the developing device 5Y, and a toner concentration sensor 56Y to detect a toner concentration in a developer G. The developing roller 51Y includes stationary magnets, a sleeve that rotates around the magnets, and the like. The developer storage contains the two-component developer G including carrier and toner.

The developing device 5Y with such a configuration operates as follows.

The sleeve of the developing roller 51Y rotates in the direction indicated by arrow A1 in FIG. 2. The developer G is carried on the developing roller 51Y by a magnetic field generated by the magnets. As the sleeve rotates, the developer G moves along the circumference of the developing roller 51Y. A ratio of toner to carrier (i.e., toner concentration) in the developer G contained in the developing device 5Y is adjusted within a predetermined range. Specifically, when low toner concentration is detected by the toner concentration sensor 56Y disposed in the developing device 5Y, fresh toner is supplied from a toner container 58 to the developing device 5Y to keep the toner concentration within the predetermined range.

The two conveying screws 55Y stir and mix the developer G with the toner supplied from the toner container 58 to the developer storage while circulating the developer Gin the developer storage separated into two compartments. In this case, the developer G moves in the direction perpendicular to the surface of the paper on which FIG. 2 is drawn. The toner in the developer G is triboelectrically charged by friction with the carrier and electrostatically attracted to the carrier. Then, the toner is carried on the developing roller 51Y together with the carrier by magnetic force generated on the developing roller 51Y.

The developer G carried on the developing roller 51Y is transported in the direction indicated by arrow A1 illustrated in FIG. 2 to the doctor blade 52Y. The amount of developer G on the developing roller 51Y is adjusted by the doctor blade 52Y, after which the developer G is transported to a development range opposite the photoconductor drum 1Y. The toner in the developer G is attracted to the electrostatic latent image formed on the photoconductor drum 1Y due to the effect of an electric field generated in the development range. As the sleeve rotates, the developer G remaining on the developing roller 51Y reaches an upper part of the developer storage and separates from the developing roller 51Y.

The replaceable toner container 58 is detachably attached to the developing device 5Y (the image forming apparatus 100). When the toner container 58 runs out of fresh toner, the toner container 58 is detached from the developing device 5Y (the image forming apparatus 100) and replaced with a new one.

Next, with reference to FIG. 3, a detailed description is provided of the intermediate transfer belt device according to the present embodiment.

From FIG. 3, it can be seen that the intermediate transfer belt device includes the intermediate transfer belt 8, four primary transfer rollers 9Y, 9M, 9C, and 9K, the drive roller 16, a driven rollers 17, a pre-transfer roller 18, a tension roller 19, a cleaning backup roller 20, a lubricant backup roller 21, a backup roller 22, the belt cleaning device 10, the lubricant applicator 30 for the intermediate transfer belt 8, the secondary-transfer backup roller 40, and the like.

The intermediate transfer belt 8 contacts the four photoconductor drums 1Y, 1M, 1C, and 1K bearing the toner images of the respective colors to form the primary transfer nips. The intermediate transfer belt 8 is stretched around and supported by eight rollers: the drive roller 16, the driven roller 17, the pre-transfer roller 18, the tension roller 19, the cleaning backup roller 20, the lubricant backup roller 21, the backup roller 22, and the secondary-transfer backup roller 40.

According to the present embodiment, the intermediate transfer belt 8 includes a single layer or multiple layers, including, but not limited to, polyvinylidene fluoride (PVDF), ethylene-tetrafluoroethylene copolymer (ETFE), polyimide (PI), and polycarbonate (PC), with conductive material such as carbon black dispersed therein.

The primary transfer rollers 9Y, 9M, 9C, and 9K contact the photoconductor drums 1Y, 1M, 1C, and 1K via the intermediate transfer belt 8, respectively. Specifically, the primary transfer roller 9Y for yellow contacts the photoconductor drum 1Y for yellow via the intermediate transfer belt 8. Similarly, the primary transfer roller 9M for magenta contacts the photoconductor drum 1M for magenta via the intermediate transfer belt 8. The primary transfer roller 9C for cyan contacts the photoconductor drum 1C for cyan via the intermediate transfer belt 8. The primary transfer roller 9K for black contacts the photoconductor drum 1K for black via the intermediate transfer belt 8.

The drive roller 16 is disposed in contact with an inner circumferential face of the intermediate transfer belt 8 by an angle of belt winding of about 120 degrees at a position downstream from the four photoconductor drums 1Y, 1M, 1C, and 1K in a direction of rotation of the intermediate transfer belt 8. The drive roller 16 is rotated clockwise in FIG. 3 by the drive motor, which is controlled by a controller. With such a configuration, the intermediate transfer belt 8 rotates in a predetermined direction (i.e., clockwise in FIG. 3) as indicated by arrow A2 in FIG. 3.

The driven roller 17 is disposed in contact with the inner circumferential face of the intermediate transfer belt 8 by the angle of belt winding of about 180 degrees at a position upstream from the four photoconductor drums 1Y, 1M, 1C, and 1K in the direction of rotation of the intermediate transfer belt 8. A portion of the intermediate transfer belt 8 extending from the driven roller 17 to the drive roller 16 via the four photoconductor drums 1Y, 1M, 1C, and 1K is substantially horizontal. The driven roller 17 is rotated clockwise in FIG. 3 as the intermediate transfer belt 8 rotates.

The tension roller 19 contacts an outer circumferential face of the intermediate transfer belt 8. The pre-transfer roller 18, the cleaning backup roller 20, the lubricant backup roller 21, the backup roller 22, and the secondary-transfer backup roller 40 contact the inner circumferential face of the intermediate transfer belt 8. Between the secondary-transfer backup roller 40 and the lubricant backup roller 21 is disposed the belt cleaning device 10 including a cleaning blade which contacts the cleaning backup roller 20 via the intermediate transfer belt 8.

Between the cleaning backup roller 20 and the tension roller 19 is disposed the lubricant applicator 30 which contacts the lubricant backup roller 21 via the intermediate transfer belt 8. Similar to the lubricant applicator 3 for the photoconductor drums 1, the lubricant applicator 30 for the intermediate transfer belt 8 includes a lubricant supply roller, a solid lubricant, and a compression spring. The lubricant supply roller rotating counterclockwise in FIG. 3 rubs a small amount of lubricant from the solid lubricant and applies the lubricant to the surface of the intermediate transfer belt 8.

As the intermediate transfer belt 8 rotates, the plurality of rollers 17 through 22 and 40 other than the drive roller 16 is driven to rotate.

From FIG. 3, it can be seen that the secondary-transfer backup roller 40 contacts the secondary transfer roller 70 via the intermediate transfer belt 8 and the secondary transfer belt 72. The secondary-transfer backup roller 40 includes a cylindrical core made of, for example, stainless steel and the like, having an elastic layer on the outer circumferential face of the core. The elastic layer is made of acrylonitrile-butadiene rubber (NBR). The elastic layer has a volume resistivity ranging from approximately 10⁷ to 10⁸ Ωcm, and a hardness ranging from approximately 48 to 58 degrees on Japanese Industrial Standards A hardness (JIS-A hardness) scale. The elastic layer has a thickness of approximately 5 mm.

According to the present embodiment, the secondary-transfer backup roller 40 is electrically connected to a power source, which applies a high voltage of approximately −5 kV as a secondary transfer bias to the secondary-transfer backup roller 40. With the secondary transfer bias applied to the secondary-transfer backup roller 40, the toner image primarily transferred to the surface of the intermediate transfer belt 8 is secondarily transferred onto the sheet P transported to the secondary transfer nip. The secondary transfer bias has the same polarity as the polarity of toner. In the present embodiment, the secondary transfer bias is a direct current voltage in a negative polarity. With this configuration, the toner carried on the outer circumferential face (a toner bearing face) of the intermediate transfer belt 8 electrostatically moves from the secondary-transfer backup roller 40 side toward the secondary-transfer belt device 69 due to a secondary transfer electric field.

In the present embodiment, the secondary transfer bias having the negative polarity is applied to the secondary-transfer backup roller 40. Alternatively, a secondary transfer bias having a positive polarity may be applied to the secondary transfer roller 70 (secondary transfer belt 72), or secondary transfer biases may be applied to both of the secondary-transfer backup roller 40 and the secondary transfer roller 70.

Next, the secondary-transfer belt device 69 is described in detail below with reference to FIG. 3 and FIG. 4. FIG. 4 is a top view of the secondary-transfer belt device 69, the sheet conveyance device 60, and the fixing device 50.

From FIGS. 3 and 4, it can be seen that the secondary-transfer belt device 69 includes the secondary transfer belt 72 as the transfer belt, the secondary transfer roller 70, a separation roller 71, and a secondary-transfer cleaning blade 73. The secondary-transfer belt device 69 reliably conveys a sheet P fed from the secondary transfer nip and facilitates separation of the sheet P from the secondary transfer belt 72.

The secondary transfer belt 72 is an endless belt stretched around and supported by multiple rollers (i.e., the secondary transfer roller 70 and the separation roller 71). The secondary transfer belt 72 is made of a material similar to that of the intermediate transfer belt 8. The secondary transfer belt 72 contacts the intermediate transfer belt 8 to form the secondary transfer nip and conveys the sheet P fed from the secondary transfer nip.

The secondary-transfer backup roller 40 and the secondary transfer roller 70 press against each other via the intermediate transfer belt 8 and the secondary transfer belt 72, thereby forming the secondary transfer nip. The secondary transfer roller 70 includes a hollow tubular core made of, for example, stainless steel, aluminum, or the like and an elastic layer coated on the core. The elastic layer has a hardness ranging from approximately 40 to 50 degrees on Asker C hardness scale. To form the elastic layer of the secondary transfer roller 70, a rubber material, such as polyurethane, ethylene-propylene-diene monomer (EPDM), and silicone, is formed into a solid or foamed state as follows. A conductive filler, such as carbon, is dispersed in the rubber material. Alternatively, an ionic conductive material is included in the rubber material. From FIG. 4, it can be seen that the secondary transfer belt 72 has a width including a range where the sheet P with a maximum size passes through.

As the secondary transfer roller 70 is rotated counterclockwise in FIG. 3 by a motor controlled by a controller, the secondary transfer belt 72 and the separation roller 71 are rotated counterclockwise in FIG. 3.

The separation roller 71 is disposed downstream from the secondary transfer nip in a conveyance direction to convey a sheet P in the sheet conveyance path. Ejected from the secondary transfer nip, the sheet P is conveyed along the secondary transfer belt 72 rotating counterclockwise in FIG. 3 and separated from the secondary transfer belt 72 at a curved portion of the secondary transfer belt 72 wound around an outer circumference of the separation roller 71 due to self stripping. In the image forming apparatus 100 using the secondary transfer belt 72, since a sheet P can be separated at the position of the separation roller 71 due to self stripping, no special bias is applied to separate the sheet P.

In the present embodiment, the secondary transfer belt 72 is stretched around and supported by the secondary transfer roller 70 and the separation roller 71. Alternatively, in another embodiment, the secondary transfer belt 72 may be stretched around and supported by more than two rollers.

The secondary-transfer cleaning blade 73 contacts the surface of the secondary transfer belt 72 to remove substances such as toner and paper dust adhering to the surface of the secondary transfer belt 72. The secondary-transfer cleaning blade 73 is pressed against the secondary transfer roller 70 via the secondary transfer belt 72 against the direction of rotation of the secondary transfer belt 72. The secondary-transfer cleaning blade 73 includes a plate-shaped blade body made of rubber such as urethane rubber with thickness of 1 to 5 mm and a blade holder made of sheet metal to support the blade body.

Next, the fixing device 50 is described in detail below with continued reference to FIGS. 3 and 4.

As illustrated in FIG. 3, the fixing device 50 includes the fixing roller 51, a heater 53, the pressure roller 52, and a pre-fixing guide plate 80.

The fixing roller 51 is a multi-layer roller constructed of a core, an elastic layer coated on the core, and a release layer coated on the elastic layer. The core is a hollow core made of a metal material such as stainless steel. The fixing roller 51 is pressed against the pressure roller 52 to form a fixing nip. The fixing roller 51 is rotated in clockwise in FIG. 3 by a drive motor.

The heater 53 is a heat source secured inside the hollow core of the fixing roller 51 to heat the fixing roller 51. As a power supply supplies power to the heater 53, the heater 53 heats the fixing roller 51 with radiation heat, and then the heated fixing roller 51 applies heat to a toner image on a sheet P.

The pressure roller 52 is mainly constructed of a core and an elastic layer coated on an outer circumferential face of the core via an adhesion layer. The pressure roller 52 is rotated counterclockwise in FIG. 2 along with the fixing roller 51 that rotates clockwise in FIG. 2.

The pre-fixing guide plate 80 is made of a metal material such as a zinc-treated steel plate or a heat-resistant resin material. The pre-fixing guide plate 80 is disposed between the sheet conveyance device 60 and the fixing device 50, facing the lower surface of the sheet P on which an unfixed image is not formed. Then, the sheet P carrying the unfixed image on the upper surface of the sheet P sent from the sheet conveyance device 60 is conveyed toward the fixing nip while being guided by the pre-fixing guide plate 80. Preferably, the pre-fixing guide plate 80 is electrically grounded so that no electric charge is accumulated. Note that the fixing roller 51, the pressure roller 52, and the pre-fixing guide plate 80 have a width including the range where the sheet P with the maximum size passes through.

A detailed description is given below of a configuration and operation of the sheet conveyance device 60 of the image forming apparatus 100 according to the present embodiment.

As illustrated in FIGS. 3 and 4, the sheet conveyance device 60 conveys the sheet P fed from the secondary-transfer belt device 69 toward the fixing device 50. As described above, a conveying belt 61 (the sheet conveyance device 60) is disposed along the sheet conveyance path from the secondary transfer belt 72 to the fixing device 50. Accordingly, the conveying belt 61 can reliably convey the sheet P even if the sheet conveyance path is long.

The sheet conveyance device 60 according to the present embodiment includes the conveying belt 61 as a conveyor, a drive roller 62, a driven roller 63, a static elimination needle 64 as a discharger, a frame 65, and the like.

The conveying belt 61, which is an endless belt, functions as the conveyor to convey a sheet P in the sheet conveyance path from the secondary transfer belt 72 to the fixing device 50. The conveying belt 61 is stretched around and supported by multiple rollers (i.e., the drive roller 62 and the driven roller 63) and rotated counterclockwise in FIG. 3 by the drive roller 62 driven by a drive motor. The conveying belt 61 is made of, for example, EPDM, PVDF, ETFE, PI, PC, or the like. The drive roller 62 and the driven roller 63 each include a shaft and two roller portions and are rotatably supported by the frame 65 of the sheet conveyance device 60 via bearings. The two roller portions are arranged with a gap in the width direction on the shaft.

From FIG. 4, it can be seen that the conveying belts 61 are disposed within a passage range M where the sheet P passes through the sheet conveyance path of the sheet conveyance device 60 in the width direction of the sheet P. The conveying belts 61 contact the sheet P in a contact range within and narrower than the passage range M. That is, the conveying belts 61 has a belt width that is within and narrower than the passage range M. The belt width is a combined length of the two conveying belts 61 in the width direction perpendicular to the conveyance direction to convey the sheet P and in the vertical direction in FIG. 4.

In particular, in the present embodiment, the two conveying belts 61 are centered around a central reference indicated by the alternate long and short dash line in FIG. 4 and arranged side by side with a gap at an equal interval in the width direction. Both of the two conveying belts 61 fall within the above-described passage range M. The surfaces of the two conveying belts 61 on which a sheet P is conveyed are exposed from an opening in the frame 65 of the sheet conveyance device 60.

The two conveying belts 61 can convey a sheet P with a minimum size that is usable in the image forming apparatus 100. Specifically, the two conveying belts 61 fall within a range where the sheet P with the minimum size passes through.

From FIGS. 3 and 4, it can be seen that static elimination needles 64 are disposed at an intermediate position in the sheet conveyance path of the sheet conveyance device 60 and function as dischargers that remove static electricity from the sheet P that the conveying belts 61 is conveying. The static elimination needles 64 include a plurality of needle-shaped members arranged on the tip (upper side in FIG. 3) of a thin metal plate and are electrically grounded.

In the present embodiment, when the conveying belts 61 convey the sheet P in the sheet conveyance path of the sheet conveyance device 60, the conveying belts 61 contact the sheet P in the contact range in the width direction of the sheet P. The static elimination needles 64 are disposed close to the sheet P that the conveying belt 61 is conveying, in a range different from the contact range. That is, the static elimination needles 64 are disposed close to the sheet P being conveyed in the sheet conveyance path, in the range where the conveying belts 61 are not disposed (i.e., outside the belt width of the conveying belts 61). In this range, the static elimination needles 64 does not hinder the conveying belt 61 from conveying the sheet P.

In particular, in the present embodiment, the two static elimination needles 64 are centered around the central reference indicated by the alternate long and short dash line in FIG. 4 and arranged side by side with a gap at an equal interval in the width direction. Further, the two static elimination needles 64 are disposed outboard of the conveying belts 61 and at both ends of the passage range M in the width direction, respectively. Tips of the two static elimination needles 64 are exposed from openings disposed in the frame 65 of the sheet conveyance device 60 so as to face (or slightly contact) both ends of the sheet P being conveyed by the conveying belt 61. Specifically, the static elimination needles 64 are disposed such that the position of the tips of the static elimination needles 64 in the height direction is equal to or slightly higher than the surface, on which the sheet P is conveyed, of the conveying belt 61.

Further, the static elimination needles 64 are located at a position sufficiently distant from the extreme downstream portion of the secondary transfer belt 72 (i.e., the position of the separation roller 71) and substantially at the center of the conveying belt 61 in the conveyance direction in which the conveying belt 61 conveys the sheet P.

As described above, in the present embodiment, the static elimination needles 64 are disposed at the intermediate position in the sheet conveyance path of the conveying belt 61 and outboard of the conveying belts 61, and the sheet P can approach the static elimination needles 64 while being conveyed in the sheet conveyance path. Therefore, the sheet P is reliably conveyed in the sheet conveyance path from the secondary transfer belt 72 to the fixing device 50 such that the sheet P does not float due to static electric buildup (“electrostatic float”).

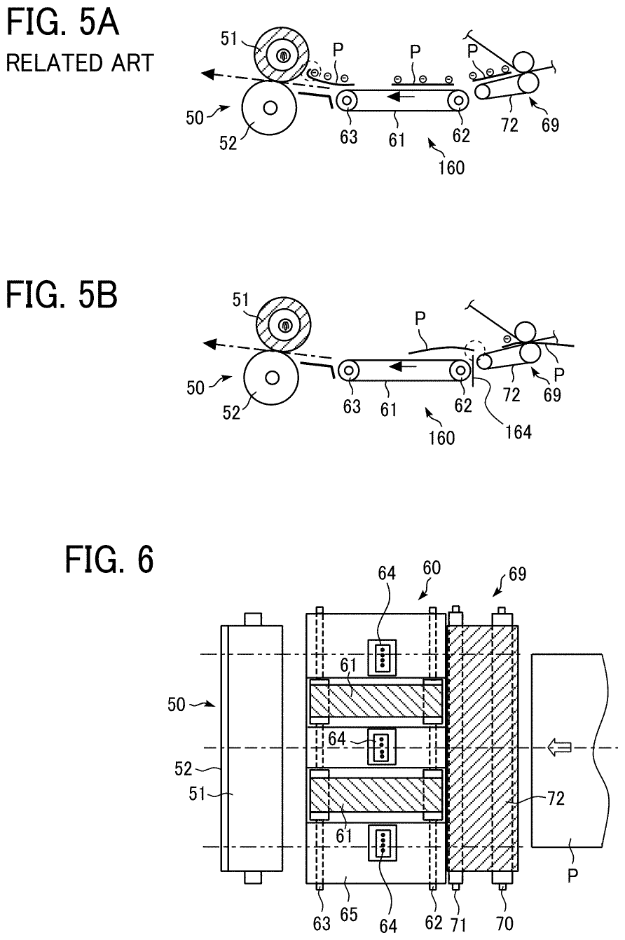

More specifically: In a comparative sheet conveyance device 160 illustrated in FIG. 5A, when a discharger is not disposed in the sheet conveyance path from the secondary transfer belt 72 to the fixing device 50, the sheet P is charged by the secondary transfer bias in the secondary transfer process (in negative polarity in the present embodiment), and then the charged sheet P is separated from the secondary transfer belt 72 without a separation bias applied to separate the sheet P, after which the sheet P is carried on the conveying belt 61. Therefore, the sheet P with static electricity is conveyed toward the fixing device 50 by the conveying belt 61. For this reason, in the portion surrounded by the broken-line circle in FIG. 5A, the sheet P may exhibit electrostatic float at the entrance of the fixing device 50. As a result, the sheet P may not be properly fed into the fixing nip and is likely to emerge dog-eared when the sheet P emerges from the fixing nip.

On the other hand, in the present embodiment, the sheet P is conveyed while being pressed against the conveying belt 61 by gravity and conveying force of the conveying belt 61, and approaches the static elimination needles 64 to remove static electricity from the sheet P. Therefore, the sheet P is less likely to float by electrostatic force in the sheet conveyance path to the fixing nip. For this reason, the sheet P is properly fed into the fixing nip and is less likely to emerge dog-eared.

In another example of the comparative sheet conveyance device 160 illustrated in FIG. 5B, when a static elimination needle 164 is disposed between the secondary-transfer belt device 69 and the comparative sheet conveyance device 160, the static elimination needle 164 is required to be disposed close to a sheet P delivered from the secondary transfer belt 72 to the conveying belt 61. Therefore, the transportability of the sheet P may be impaired by the static elimination needle 164. That is, in the portion surrounded by the broken-line circle in FIG. 5B, when the sheet P is delivered from the secondary transfer belt 72 to the conveying belt 61, the static elimination needles 164 is likely to interfere with the sheet P.

On the other hand, in the present embodiment, the sheet P is conveyed while being pressed against the conveying belt 61 by gravity and conveying force of the conveying belt 61, and approaches the static elimination needles 64 at the position where the static elimination needles 64 does not interfere with the sheet P to remove static electricity from the sheet P. Therefore, the sheet P is properly conveyed in the sheet conveyance path from the secondary transfer belt 72 to the fixing device 50.

In particular, since the static elimination needles 64 are disposed at positions sufficiently distant from the secondary-transfer belt device 69, any electric charge on the sheet P applied at the position of the secondary-transfer belt device 69 is spontaneously discharged into the air. Then, the static elimination needles 64 remove the static electricity from the sheet P in a state in which the electric charge (potential) of the sheet P is reduced to some extent. Therefore, the potential change of the sheet P due to discharging is small, and toner on the sheet P is less likely to scatter as a result. That is, deterioration of image quality due to image dust (dust particle) can be prevented.

Further, in the present embodiment, since the static elimination needle 64 having a pointed tip is used as the discharger, electric charges accumulating in the sheet P conveyed from the secondary transfer belt 72 are concentrated at and discharged to the pointed tips. Therefore, the static elimination needle 64 can efficiently remove the static electricity from the sheet P using a simple configuration.

In the present embodiment, the static elimination needle 64 is electrically grounded. Alternatively, a predetermined direct current (DC) voltage or alternating current (AC) voltage may be applied to the static elimination needle 64 from a power supply.

In the present embodiment, as illustrated in FIG. 4, the static elimination needles 64 are disposed close to at least one end of the sheet P in the width direction of the sheet P being conveyed in the sheet conveyance path of the sheet conveyance device 60.

Specifically, one of the two static elimination needles 64, which is the upper static elimination needle 64 in FIG. 4, is disposed close to one end in the width direction of the sheet P, and the other static elimination needle 64, which is the lower static elimination needle 64 in FIG. 4, is disposed close to the other end in the width direction of the sheet P. That is, in the sheet P being conveyed by the conveying belt 61, the center portion of the sheet P in the width direction contacts the conveying belts 61, and both ends of the sheet P in the width direction are opposed to (or slidably contact) the static elimination needles 64, respectively.

As described above, floating of the sheet P due to electrostatic force at the entrance of the fixing device 50 is likely to occur at both ends in the width direction of the sheet P. In the present embodiment, the static elimination needles 64 are reliably disposed close to both ends of the sheet P, thereby preventing the sheet P from floating. As a result, the sheet P is less likely to emerge dog-eared.

FIG. 6 is a top view of a sheet conveyance device 60 and the surrounding structure according to a first variation and corresponds to FIG. 4 according to the above-described embodiment.

As illustrated in FIG. 6, the sheet conveyance device 60 according to the first variation includes a static elimination needle 64 disposed at the center in the width direction in addition to the static elimination needles 64 disposed at both ends in the width direction, differing from that of the above-described embodiment. The three static elimination needles 64 are all located at the middle of the conveying belt 61 in the conveyance direction in which the conveying belt 61 conveys the sheet P, and are located outside the range where the conveying belts 61 are disposed in the width direction.

Similarly to the above-described embodiment, the sheet conveyance device 60 according to the first variation having a such configuration can also properly convey a sheet P such that the sheet P does not float due to electrostatic force in the sheet conveyance path from the secondary transfer belt 72 to the fixing device 50.

In particular, in the first variation, since the static elimination needles 64 reliably removes the static electricity from the sheet P at the center in addition to both ends in the width direction, thereby further reducing the deterioration in image quality due to image dust.

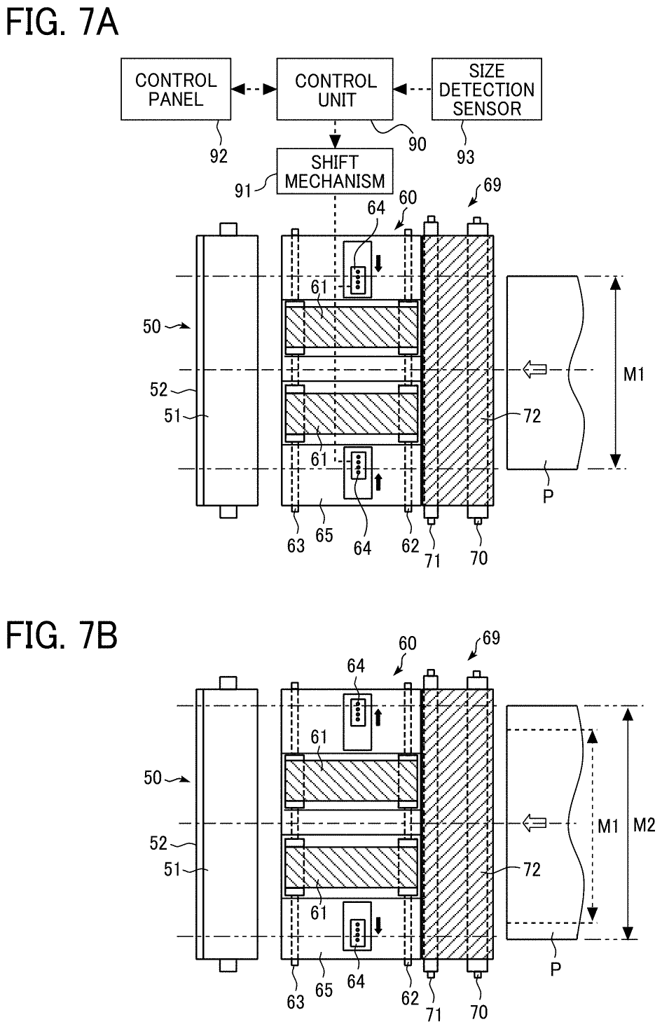

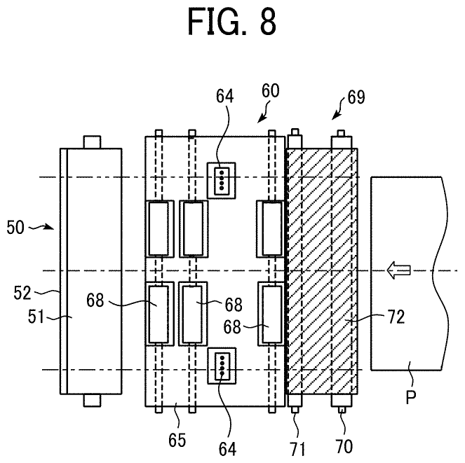

FIGS. 7A and 7B are a top views of a sheet conveyance device 60 and the surrounding structure according to a second variation and correspond to FIG. 4 according to the above-described embodiment.

As illustrated in FIGS. 7A and 7B, the sheet conveyance device 60 according to the second variation includes a shift mechanism 91 that moves the static elimination needles 64 in the width direction of the sheet P (the vertical direction in FIGS. 7A and 7B).

The static elimination needle 64 is moved by the shift mechanism 91 so as to be close to the end of the sheet P in the width direction to match the size in the width direction of the sheet P conveyed in the sheet conveyance path of the sheet conveyance device 60. More specifically, as illustrated in FIG. 7A, when a sheet P having a length M1 in the width direction is conveyed (for example, an A4 size sheet P is conveyed in the lengthwise direction), the shift mechanism 91 controlled by a control unit 90 moves the static elimination needles 64 toward the center in the width direction indicated by the black arrows in FIG. 7A to match the length M1 in the width direction of the sheet P. On the other hand, as illustrated in FIG. 7B, when a sheet P having a length M2, which is greater than the length M1, in the width direction is conveyed (for example, an A3 size sheet P is conveyed in the lengthwise direction), the shift mechanism 91 controlled by the control unit 90 moves the static elimination needles 64 toward the ends in the width direction indicated by the black arrows in FIG. 7B to match the length M2 in the width direction of the sheet P.

The sheet conveyance device 60 according to the second variation having a such configuration can also properly convey a sheet P such that the sheet P does not float due to electrostatic force regardless of the size in the width direction of the conveyed sheet P.

The shift mechanism 91 that moves the static elimination needles 64 employs, for example, a rack and pinion mechanism, a cam mechanism, or the like. The size of the sheet P in the width direction may be directly detected by a size detection sensor 93 disposed, for example, in the sheet feeder 26, or may be indirectly detected based on data about the sheet P, which is input to a control panel 92 disposed on the exterior of the image forming apparatus 100 by a user. The control unit 90 causes the shift mechanism 91 to moves the static elimination needles 64 based on such a detection result.

If the static elimination needle 64 is manually moved, the static elimination needle 64 is linked with a side fence of the sheet feeder 26 that is moved in the width direction by manual operation. The side fence regulates the position of the sheet P in the width direction. Thus, the static elimination needle 64 can be moved in the width direction along with the side fence.

FIG. 8 is a top view of a sheet conveyance device 60 and the surrounding structure according to a third variation and corresponds to FIG. 4 according to the above-described embodiment.

As illustrated in FIG. 8, the sheet conveyance device 60 according to the third variation includes a plurality of conveying rollers 68 instead of the conveying belt 61 as the conveyor that conveys the sheet P in the sheet conveyance path from the secondary transfer belt 72 to the fixing device 50.

More specifically, each of the three conveying rollers 68 includes a shaft and multiple roller portions. The multiple roller portions are arranged with a gap in the width direction on the shaft. The three conveying rollers 68 are arranged in parallel at intervals in the conveyance direction to convey the sheet P, and each conveying roller 68 rotates along the conveyance direction.

In the third variation, the static elimination needles 64 are disposed at the intermediate position in the sheet conveyance path of the sheet conveyance device 60 and outside a range where the roller portions of the conveying rollers 68 as the conveyors are disposed. The sheet P can approach the static elimination needles 64 while being conveyed in the sheet conveyance path.

Similarly to the above-described embodiment, the sheet conveyance device 60 according to the third variation having a such configuration can also properly convey a sheet P such that the sheet P does not float due to electrostatic force in the sheet conveyance path from the secondary transfer belt 72 to the fixing device 50.

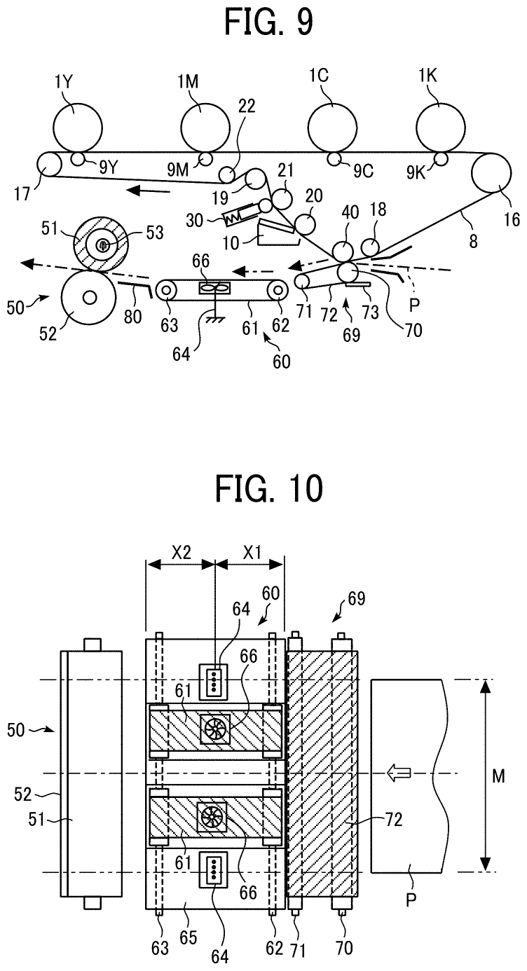

FIG. 9 is a schematic view of a sheet conveyance device 60 and the surrounding structure according to a fourth variation and corresponds to FIG. 3 according to the above-described embodiment. FIG. 10 is a top view of the sheet conveyance device 60 and the surrounding structure according to the fourth variation and corresponds to FIG. 4 according to the above-described embodiment.

As illustrated in FIGS. 9 and 10, similarly to the above-described embodiment, and the first and second variations, the sheet conveyance device 60 according to the fourth embodiment includes the conveying belt 61 as the conveyor, the drive roller 62, the driven roller 63, the static elimination needle 64 as the discharger, the frame 65, and the like. The sheet conveyance device 60 according to the fourth variation further includes a suction fan 66 as a contact assist mechanism to assist contacting the sheet P being conveyed in the sheet conveyance path with the conveying belt 61.

Specifically, the suction fan 66 is disposed on the frame 65, facing the inner circumferential face of the conveying belt 61. The suction fan is opposed to a sheet P, which is being conveyed in the sheet conveyance path by the conveying belt 61, via the conveying belt 61. The conveying belt 61 has a plurality of holes over the entire surface of the conveying belt 61 that are small through-holes which do not hinder the conveyance of the sheet P. Further, the suction fan 66 is controlled so as to be turned on (i.e., the suction fan 66 sucks air) at least when the sheet P is on the conveying belt 61.

With the suction fan 66 as the contact assist mechanism, even if various disturbances occur, the sheet P can be in close contact with the conveying belt 61 stably as compared with the case in which the sheet P contacts the conveying belt 61 only by the force of gravity. Accordingly, the distance between the sheet P being conveyed on the conveying belt 61 and the static elimination needle 64 is also stable without deviation, and the static elimination needle 64 functions efficiently. As a result, the sheet conveyance device 60 can convey the sheet P such that the sheet P does not float due to electrostatic force. In particular, in the fourth variation, instead of using electrostatic force to bring the sheet P into close contact with the conveying belt 61, the suction fan 66 which does not generate electrostatic force is used as the contact assist mechanism without affecting the efficiency to remove static electricity from the sheet P by the static elimination needle 64.

In the fourth variation, the position of the static elimination needles 64 in the conveyance direction in which the conveying belt 61 conveys the sheet P in the sheet conveyance path, which is the lateral direction in FIGS. 9 and 10, substantially coincides with the position of the suction fans 66 in the conveyance direction. That is, the static elimination needles 64 and the suction fans 66 are disposed at the substantially same position in the lateral direction in FIGS. 9 and 10. This is because, suction force to attract the sheet P is strong and the sheet P strongly contacts the conveying belt 61 at a position near the suction fan 66 in the conveyance direction as compared with a position farther from the suction fan 66. Since the static elimination needles 64 are disposed near the suction fans 66 in the conveyance direction, the static elimination needles 64 function efficiently.

In the fourth variation, the static elimination needles 64 are disposed at the center of the conveying belt 61 or downstream from the center in the conveyance direction. That is, with reference to FIG. 10, the static elimination needles 64 are arranged such that the positional relation between the static elimination needles 64 and the conveying belts 61 in the conveyance direction satisfies that a distance X1 is equal to or more than a distance X2. Here, the distance X1 is the length from the extreme upstream portion of the conveying belt 61 to the static elimination needles 64, and the distance X2 is the length from the static elimination needles 64 to the extreme downstream portion of the conveying belt 61. Note that a distance X1+X2 is the length of the upper surface, on which the sheet P is conveyed, of the conveying belt 61 in the conveyance direction.

Accordingly, the static elimination needles 64 efficiently remove static electricity from the sheet P after the potential of the sheet P is reduced to a certain potential or less by spontaneous discharge, and occurrence of an abnormal image (e.g., image dust or discharge mark) due to discharging is reduced.

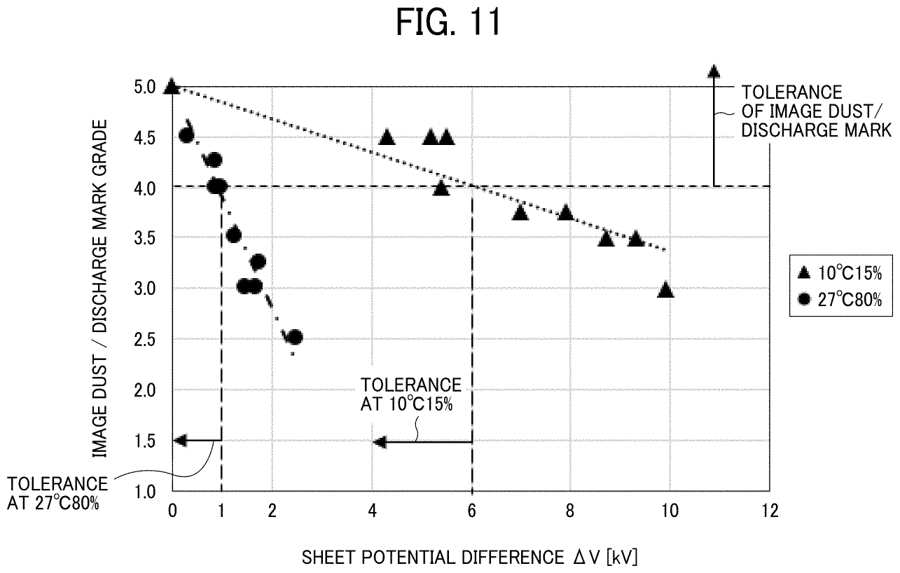

FIG. 11 is a graph illustrating a relation between a potential difference of a sheet P before and after discharging, and the occurrence of the image dust or discharge mark. As illustrated in FIG. 11, the abnormal image worsens as the potential difference of the sheet P increases. The tolerance of the potential difference with which image on the sheet P is allowable (i.e., grade 4 or higher) is 1 kV or less when the usage environment of the image forming apparatus 100 is high temperature and high humidity. When the usage environment is low temperature and low humidity, the tolerance of the potential difference is 6 kV or less.

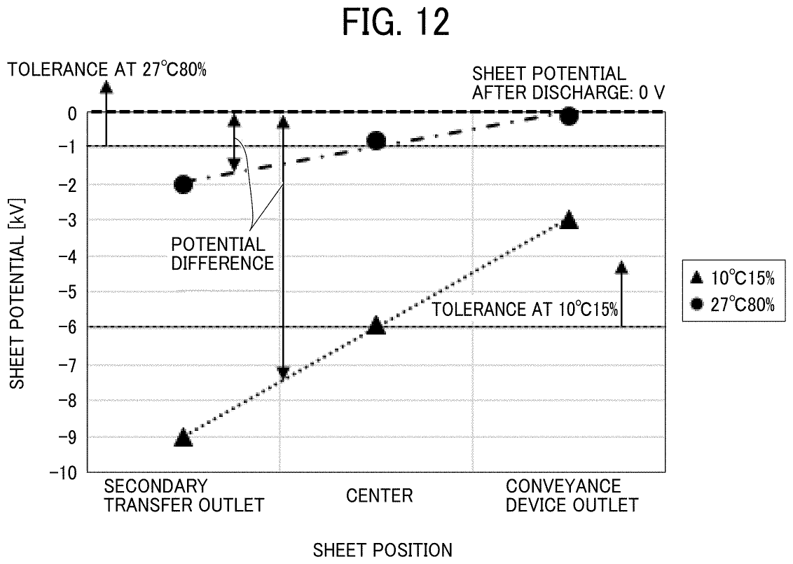

FIG. 12 is a graph illustrating a relation between a position of a sheet P conveyed in the conveyance direction and a potential of the sheet P. As illustrated in FIG. 12, as the sheet P is conveyed, the static electricity is gradually discharged from the sheet P, and the potential of the sheet P decreases as compared with the potential immediately after the secondary transfer process. However, the potential of the sheet P does not reach 0 V completely until the sheet P is conveyed to the outlet of the sheet conveyance device 60 (or the entry of the fixing device 50). On the other hand, since the potential of the sheet P becomes 0 V after passing through the static elimination needles 64, the potential difference between 0 V and the potential before the sheet P passes through the static elimination needles 64 is the potential difference before and after discharging. To keep the image dust and discharge mark to an acceptable level, the potential difference before and after discharging is required to fall within the range described in FIG. 11 (1 kV or less under high temperature and high humidity, 6 kV or less under low temperature and low humidity). Therefore, since the position of the static elimination needles 64 in the conveyance direction is at the center or downstream from the center of the conveying belt 61, the occurrence of an abnormal image (e.g., image dust and discharge mark) is reduced, and the static elimination needle 64 functions more efficiently to remove static electricity.

As described above, the sheet conveyance device 60 according to the above embodiments includes the conveying belt 61 as the conveyor that conveys the sheet P in the sheet conveyance path from the secondary transfer belt 72 to the fixing device 50, the static elimination needle 64 as the discharger disposed at the intermediate position in the sheet conveyance path. The static elimination needle 64 removes static electricity from the sheet P that the conveying belt 61 is conveying in the sheet conveyance path. The conveying belt 61 is disposed within the passage range M where the sheet P passes through the sheet conveyance path of the sheet conveyance device 60 and contacts the sheet P in the contact range narrower than the passage range M. The static elimination needles 64 are disposed close to the sheet P in a range different from the contact range where the conveying belts 61 contacts the sheet P that the conveying belt 61 is conveying in the sheet conveyance path of the sheet conveyance device 60 in the width direction.

With this configuration, the sheet P is reliably conveyed in the sheet conveyance path from the secondary transfer belt 72 to the fixing device 50 without floating due to electrostatic force.

As a result, according to the present disclosure, a sheet conveyance device and an image forming apparatus incorporating the sheet conveyance device can be provided, in which a sheet is reliably conveyed in a sheet conveyance path from a transfer belt to a fixing device without floating due to electrostatic force.

In the above-described embodiments, the present disclosure is applied to the image forming apparatus 100 employing the secondary-transfer belt device 69 including the secondary transfer belt 72 as the transfer belt. On the other hand, the present disclosure can also be applied to an image forming apparatus of so-called direct transfer type. The image forming apparatus of the direct transfer type does not include an intermediate transferor such as an intermediate transfer belt or an intermediate transfer drum, and includes a photoconductor drum as an image bearer on which a toner image is formed by a developing device, and a transfer belt that contacts the photoconductor drum to form a transfer nip and transfers the toner image on the photoconductor drum to a sheet conveyed to the transfer nip.

Further, in the above-described embodiments, the present disclosure is applied to the image forming apparatus 100 that forms the color image. Meanwhile, the present disclosure can also be applied to an image forming apparatus that forms only a monochrome image.

Further, in the present embodiment, the needle-shaped static elimination needle 64 is used as the discharger installed in the sheet conveyance device 60, but the discharger is not limited thereto, and for example, a static elimination wire or a flocked static elimination hairs can be used as the discharger.

In such configurations, effects similar to those described above are also attained.

The above-described embodiments are illustrative and do not limit the present disclosure. Thus, numerous additional modifications and variations are possible in light of the above teachings. It is therefore to be understood that within the scope of the present disclosure, the present disclosure may be practiced otherwise than as specifically described herein. The number, position, and shape of the components described above are not limited to those embodiments described above. Desirable number, position, and shape can be determined to perform the present disclosure.

The sheet P is herein defined as any sheet-shaped recording medium, such as coated paper, label paper, overhead projector (OHP) transparency, or a metal sheet in addition to plain paper.

In the specification of the present disclosure, the state in which “the discharger is disposed close to the sheet” includes not only a state in which the discharger faces the sheet with a slight gap, but also a state in which the discharger contacts the sheet.

What is claimed is:

1. A sheet conveyance device comprising:
a conveyor configured to convey a sheet in a sheet conveyance path and contact the sheet in a contact range within and narrower than a passage range where the sheet passes through the sheet conveyance path in a width direction of the sheet; and
a discharger configured to remove static electricity from the sheet that the conveyor is conveying in the sheet conveyance path,
wherein the discharger is disposed at an intermediate position in the sheet conveyance path in a range different from the contact range and close to the sheet that the conveyor is conveying in the sheet conveyance path.

2. The sheet conveyance device according to claim 1,
wherein the conveyor is an endless belt disposed in the contact range in the width direction of the sheet.

3. The sheet conveyance device according to claim 2,
wherein the discharger is disposed at a center of the endless belt or downstream from the center in a conveyance direction in which the conveyor conveys the sheet in the sheet conveyance path.

4. The sheet conveyance device according to claim 1, further comprising a contact assist mechanism configured to assist contacting the sheet with the conveyor.

5. The sheet conveyance device according to claim 4,
wherein the contact assist mechanism is a suction fan, and
wherein a position of the discharger substantially coincides with a position of the suction fan in a conveyance direction in which the conveyor conveys the sheet in the sheet conveyance path.

6. The sheet conveyance device according to claim 1,
wherein the discharger is disposed close to at least one end of the sheet in the width direction of the sheet that the conveyor is conveying in the sheet conveyance path.

7. The sheet conveyance device according to claim 1, further comprising a shift mechanism configured to move the discharger in the width direction of the sheet so that the discharger is disposed close to at least one end of the sheet in the width direction of the sheet that the conveyor is conveying in the sheet conveyance path according to a size of the sheet.

8. The sheet conveyance device according to claim 1,
wherein the discharger is a static elimination needle.

9. An image forming apparatus comprising:
a transfer belt;
a fixing device; and
the sheet conveyance device according to claim 1,
wherein the sheet conveyance device is configured to convey the sheet in the sheet conveyance path from the transfer belt to the fixing device.
